(19) United States
(12) Patent Application Publication
(10) Pub. No.: US 2003/0212742 A1
(43) Pub. Date: Nov. 13, 2003

(54) Method, node and network for compressing and transmitting composite images to a remote client

(76) Inventors: Roland M. Hochmuth, Fort Collins, CO (US); Byron A. Alcorn, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/141,435

(22) Filed: May 7, 2002

(51) Int. Cl. G06F 15/16

(52) U.S. Cl. 709/204

(57) ABSTRACT

A method of compositing image partitions and distributing a composite image to a remote node comprising receiving a plurality of image renderings from a respective plurality of rendering nodes, assembling the plurality of image renderings into a composite image, compressing the composite image, and transmitting the compressed composite image across a routable network having the remote node interconnected therewith is provided. A node for assembling image portions into a composite image comprising a processing element, a routable network interface, a compositing element operable to receive a first and second data stream input thereto and to assemble the data streams into a composite data stream defining the composite image, and a memory module maintaining a compression engine executable by the processing element and operable to compress the composite image and output the compressed composite image through the network interface is provided.

### TECHNICAL FIELD OF THE INVENTION

This invention relates to a computer graphical display system and, more particularly, to methods and systems for compressing and transmitting composite images to a remote client.

### BACKGROUND OF THE INVENTION

Designers and engineers in manufacturing and industrial research and design organizations are today driven to keep pace with ever-increasing design complexities, shortened product development cycles and demands for higher quality products. To respond to this design environment, companies are aggressively driving front-end loaded design processes where a virtual prototype becomes the medium for communicating design information, decisions and progress throughout their entire research and design entities. What was once component-level designs that were integrated at manufacturing have now become complete digital prototypes—the virtual development of the Boeing 777 airliner is one of the more sophisticated and well-known virtual designs to date.

With the success of an entire product design in the balance, accurate, real-time visualization of these models is paramount to the success of the program. Designers and engineers require availability of visual designs in up-to-date form with photo-realistic image quality. The ability to work concurrently and collaboratively across an extended enterprise often having distributed locales is tantamount to a programs operability and success. Furthermore, virtual design enterprises require scalability so that the virtual design environment can grow and accommodate programs that become ever more complex over time.

### SUMMARY OF THE INVENTION

In accordance with an embodiment of the present invention, a method of compositing image partitions and distributing a composite image to a remote node comprising receiving a plurality of image renderings from a respective plurality of rendering nodes, assembling the plurality of image renderings into a composite image, compressing the composite image, and transmitting the compressed composite image across a routable network having the remote node interconnected therewith is provided.

In accordance with another embodiment of the present invention, a node for assembling image portions into a composite image comprising a processing element, a routable network interface, a compositing element operable to receive a first and second data stream input thereto and to assemble the data streams into a composite data stream defining the composite image, and a memory module maintaining a compression engine executable by the processing element and operable to compress the composite image and output the compressed composite image through the network interface is provided.

In accordance with another embodiment of the present invention, a network for generating composite images and distributing the composite images to a remote node comprising a plurality of rendering nodes operable to render a respective image portion and a compositing node comprising a compositing element operable to receive the respective image portions in respective data streams and assemble the data streams into a composite image, a compression engine operable to compress the composite image, and a network interface operable to transmit the compressed composite image to a routable network in communication therewith is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of an exemplary conventional computer graphical display system according to the prior art;

FIG. 2 is a block diagram of a scaleable visualization system including graphics pipelines in which an embodiment of the present invention may be implemented for advantage;

FIG. 3 is a block diagram of a prior art compositor configuration;

FIG. 4 is a block diagram of an improved compositor configuration according to an embodiment of the present invention;

FIG. 5 is a block diagram of a master system that may be implemented in a visualization system according to an embodiment of the present invention;

FIG. 6 is a block diagram of a master pipeline that may be implemented in a visualization system according to an embodiment of the present invention;

FIG. 7 is a block diagram of slave pipelines configured according to an embodiment of the present invention;

FIG. 8 is a frontal view of a display device displaying a window on a screen thereof according to an exemplary prior art compositing technique;

FIG. 9 is a front view of a display device having respective screen portions according to an embodiment of the present invention;

FIG. 10 is a block diagram of a visualization system having a compositor according to an embodiment of the present invention;

FIG. 11 is a flowchart depicting the functionality of the compositor according to an embodiment of the present invention;

FIG. 12 is a flowchart providing a more detailed functionality of the compositor according to an embodiment of the present invention; and

FIG. 13 is a block diagram of a preferred embodiment of an input mechanism and an output mechanism of a compositor according to an embodiment of the present invention.

### DETAILED DESCRIPTION OF THE DRAWINGS

The preferred embodiment of the present invention and its advantages are best understood by referring to FIGS. 1 through 13 of the drawings, like numerals being used for like and corresponding parts of the various drawings.

FIG. 1 depicts a block diagram of an exemplary conventional computer graphical display system 5 according to the prior art. A graphics application 3 stored on a computer 2 defines, in data, an object to be rendered by system 5. To render the object, application 3 transmits graphical data defining the object to graphics pipeline 4, which may be implemented in hardware, software, or a combination thereof. Graphics pipeline 4, through well-known techniques, processes the graphical data received from application 3 and stores the graphical data in a frame buffer 6. Frame buffer 6 stores the graphical data necessary to define the image to be displayed by a monitor 8. In this regard, frame buffer 6 includes a set of data for each pixel displayed by monitor 8. Each set of data is correlated with the coordinate values that identify one of the pixels displayed by monitor 8, and each set of data includes the color value of the identified pixel as well as any additional information needed to appropriately color or shade the identified pixel. Normally, frame buffer 6 transmits the graphical data stored therein to monitor 8 via a scanning process such that each line of pixels defining the image displayed by monitor 8 is sequentially updated.

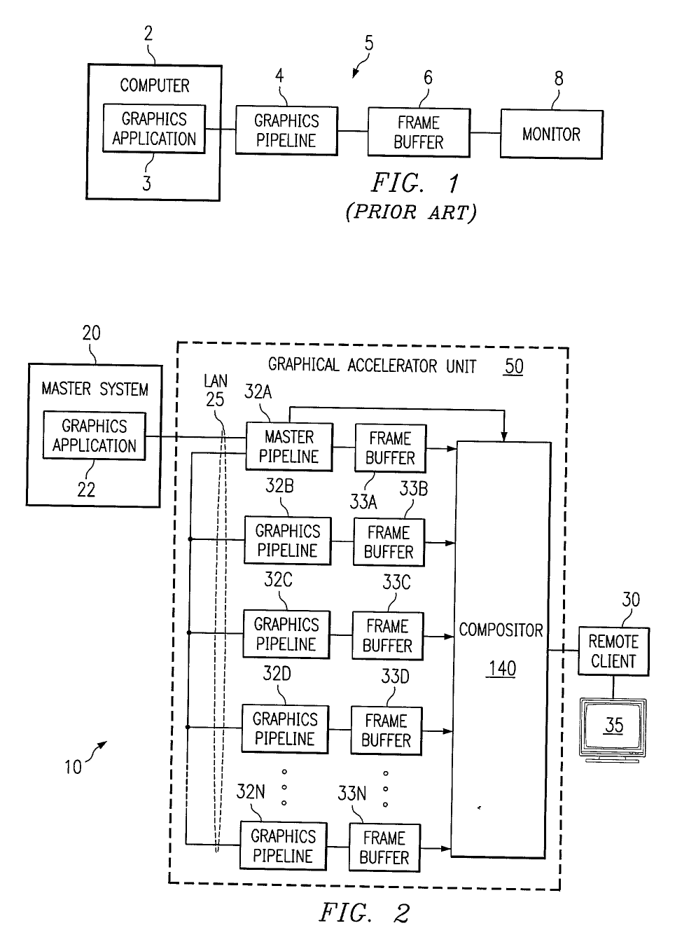

In FIG. 2, there is a block diagram of the exemplary scaleable visualization system 10 including graphics, or rendering, pipelines 32A-32N in which an embodiment of the present invention may be implemented for advantage. Visualization center 10 includes master system 20 interconnected, for example via a network 25 such as a gigabit local area network, with master pipeline 32A that is connected with one or more slave graphics pipelines 32B-32N that may be implemented as graphics-enabled workstations. Master system 20 may be implemented as an X server and may maintain and execute a high performance three-dimensional (3D) rendering application, such as OpenGL(R). Renderings may be distributed from one or more workstations 32A-32N across visualization center 10 assembled by a compositor 40 and displayed at a remote client 30, such as a workstation, as a single image.

Master system 20 runs an application 22, such as a computer-aided design/computer-aided manufacturing (CAD/CAM) application, and may control and/or run a process, such as X server, that controls a bitmap display device and distributes 3D-renderings to multiple 3D-rendering pipelines maintained at workstations 32A-32N. Network 25 provides connections to rendering pipelines and master system 20 are had by network 25.

Rendering pipelines may be responsible for rendering to a portion, or sub-screen, of a full application visible frame buffer. In such a scenario, each rendering pipeline defines a screen space division that may be distributed for application rendering requests. A digital video connector, such as a DVI connector, may provide connections between rendering pipelines and compositor 40. Alternatively, a plurality of rendering pipelines may render a common portion of a visible frame buffer such as is performed in a super-sample mode of compositing.

Image compositor 40 is responsible for assembling sub-screens from respective pipelines and recombining the multiple sub-screens into a single screen image for presentation on a monitor 35. The connection between compositor 40 and monitor 35 may be had via a standard analog monitor cable or digital flat panel cable. Image compositor 40 is operable to assemble sub-screens in one of various modes. For example, compositor 40 may assemble sub-screens provided by rendering pipelines where each sub-screen is a rendering of a distinct portion of a composite image. In this manner, compositor 40 merges different portions of a rendered image, respectively provided by each pipeline, into a single, composite image prior to display of the final image. Compositor 40 may also operate in an accumulate mode in which all pipelines provide renderings of a complete screen. In the accumulate mode, compositor 40 sums the pixel output from each rendering pipeline and averages the result prior to display. Other modes of operation are possible. For example, a screen may be partitioned and have multiple pipelines, such as rendering pipelines, assigned to a particular partition, while other pipelines are assigned to one or more remaining partitions in a mixed-mode of operation. Thereafter sub-screens provided by rendering pipelines assigned to a common partition are averaged as in the accumulate mode.

It should be understood that the compositing techniques described are exemplary only and are chosen to facilitate an understanding of the invention. Numerous other compositing techniques may be implemented in a system of the present invention and may be used in conjunction with, or in lieu of, the described compositing techniques.

Master pipeline 32A receives graphical data from application 22 run by master system 20. Master pipeline 32A preferably renders two-dimensional (2D) graphical data to frame buffer 33A and routes three-dimensional graphical data to slave pipelines 32B-32N, which render the 3D graphical data to frame buffers 33B-33N.

Each frame buffer 33A-33N outputs a stream of graphical data to compositor 40. Compositor 40 is configured to combine or composite each of the data streams from frame buffers 33A-33N into a single data stream that is provided to a monitor 35, such as a cathode ray tube or other device for displaying an image. The graphical data provided to monitor 35 by compositor 40 defines the image to be displayed by monitor 35 and is based on the graphical data received from frame buffers 33A-33N.

Preferably, master system 20 and each of pipelines 32A-32N are respectively implemented via stand-alone computer systems, or workstations. However, it is possible to implement master system 20 and pipelines 32A-32N in other configurations. For example, master system 20 and master pipeline 32A may be implemented via a single computer workstation. A computer used to implement master system 20 and/or one or more pipelines 32A-32N may be utilized to perform other desired functionality when the workstation is not being used to render graphical data as opposed to prior art video fabric solutions, such as customized circuit-switched solutions, dedicated for one-to-one video transmissions. For example, master system 20 and/or pipelines 32A-32N may be operatively connected with a routable network, such as the Internet a local area network, a wide area network, or another network operable to perform data transfers via a routable networking protocol. As mentioned hereinabove, master system 20 and pipelines 32A-32N may be interconnected via a local area network 25 although other types of interconnection circuitry may be utilized without departing from the principles of the present invention.

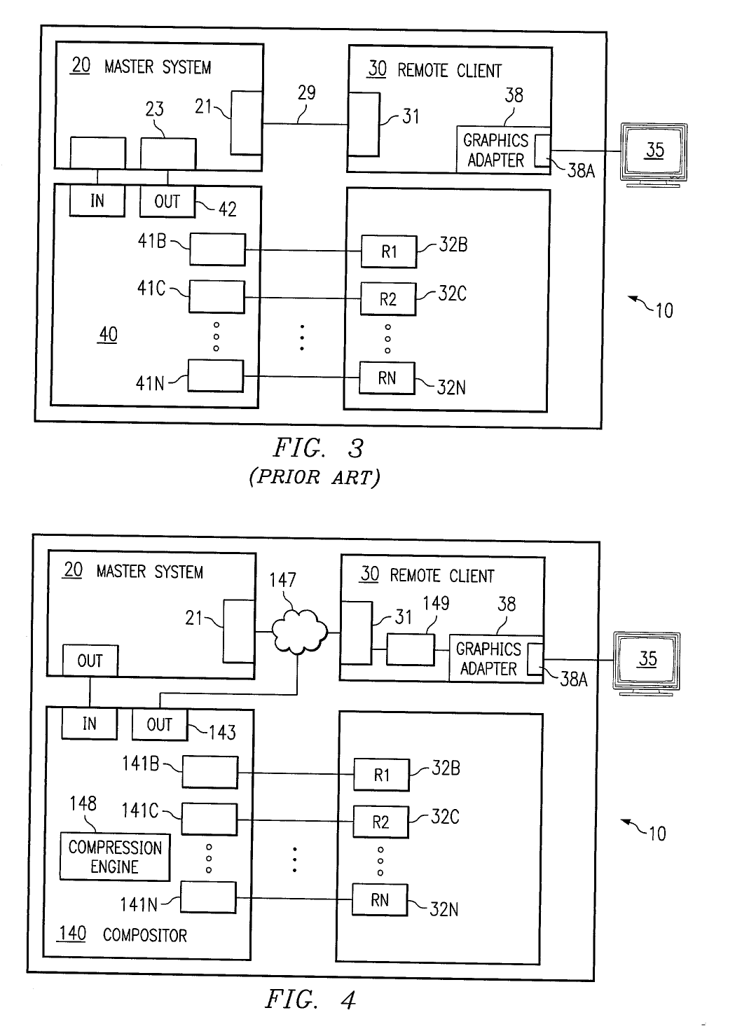

Heretofore, existing image compositing solutions have not had the capability to transmit video over a standard routable network to a remote client. Consequently, customized video fabrics have been required to facilitate image compositing to a remote client 40. To better illustrate an improvement achieved by the present invention, consider first FIG. 3 which show a remote client 30 that has a display device 35 connected therewith, for example via a graphics output interface 38 having a DVI output 38A, for displaying composite images as is conventional. Remote client 30 may issue one or more commands defining a request for an image rendering to master system 20 interconnected therewith via respective network interface cards 31 and 21.

Application 22 may run parallel and asynchronously from client requests for an image to be composited, compressed and transferred thereto. For example, master system 20 may have a display device connected therewith for an operator to direct operation of application 22 running thereon. Another operator at a remote client may participate collaboratively with generation, design, or another manipulation for a 3D image by periodically requesting delivery of an image thereto. Thus, an operator may direct application 22 to render a particular 3D image and another operator at a remote client may request transfer of the 3D image to the remote client for display thereof.

Alternatively, master system 20 may forward a command and/or associated data required to render an image to one or more rendering nodes, such as slave pipelines 32B-32N. Each of slave pipelines 32B-32N may process the data transmitted thereto by master system 20 and forward the rendered data, also referred to herein as a data stream, to a respective input 41A-41N, such as a DVI input, of compositor 40. Compositor 40 then composites, or assembles, the individual data streams received at inputs 41B-41N and transmits the composite image from an output 42 thereof to an input 23, such as a DVI input, of master system 20. Master system 20 then forwards the composite image to remote client 30 over a dedicated communication line 29 where the composite image may be displayed on display device 35.

The present invention, on the other hand, incorporates an improved compositor 140 in system 10 for improved distribution of images composited thereby, as shown by the block diagram of FIG. 4. Remote client 30 may have display device 35 connected therewith, for example via graphics output interface 38 having a DVI output 38A, for displaying composited images. Remote client 30 may issue one or more commands defining a request for an image rendering to a network 147, such as a public IP network or another routable network. Network 147 functions to transmit the one or more commands issued by remote client 30 across network interface 21 to master system 20. Thus, remote client 30 may be equipped with standard network interfacing equipment thereby enabling an operator of system 10 to forego acquisition and maintenance of a customized network for distributing composite images to remote clients thereof.

Master system 20 may forward a command and/or associated data required to render a requested image to one or more rendering nodes, such as slave pipelines 32B-32N. Each of slave pipelines 32B-32N may process the data transmitted thereto by master system 20 and forward the rendered data, also referred to herein as a data stream, to a respective input 141A-141N, such as a DVI input, of compositor 140. Compositor 140 then composites, or assembles, the individual data streams received at inputs 141B-141N, as described more fully hereinbelow, and transmits the composite image from a network interface 143 to network 147 for transit thereacross to network interface 31 of remote client 30 as described more fully hereinbelow with reference to FIG. 13.

Preferably, compositor 140 is equipped with a compression engine 148 for compressing images composited thereby prior to transmitting the composite image or other data to network 147. Accordingly, remote client 30 maintains a decompression engine 149 for extracting the composite image from compressed data received at network interface 31. Compression engine 148 may be implemented as any one of numerous freely-available or commercially-available compression algorithms or, alternatively, compression engine 148 may be proprietary. Examples of compression algorithms that may be implemented as compression engine 148 include, but not by way of limitation, JPEG-LS compression algorithms, or variations thereof, compression algorithms utilizing a C-implementation of the well-known Lempel-Ziv (LZ) Welch algorithm, gzip or another variation of LZ-adaptive-dictionary-based compression, any one of numerous differential pulse code modulation (DPCM) engines such as delta-modulation and adaptive DPCM, run length encoding, Shannon Fano coding, Huffman coding, or other algorithms now known or later developed that functions to reduce the size of a composite image prior to transmission thereof to remote client 30. Alternatively, compression engine 148 may be implemented as a dedicated integrated circuit comprising logic circuitry operable to implement compression on composite images input thereto. Preferably, compression engine 148 implements JPEG-LS compression or a derivative thereof.

In FIG. 5, there is a block diagram of master system 20 that may be implemented in a visualization system according to an embodiment of the present invention. Master system 20 stores graphics application 22 in a memory unit 40. Through conventional techniques, application 22 is executed by an operating system 50 and one or more conventional processing elements 55 such as a central processing unit. Operating system 50 performs functionality similar to conventional operating systems, controls the resources of master system 20, and interfaces the instructions of application 22 with processing element 55 as necessary to enable application 22 to properly run.

Processing element 55 communicates to and drives the other elements within master system 20 via a local interface 60, which may comprise one or more buses. Furthermore, an input device 65, for example a keyboard or a mouse, can be used to input data from a user of master system 20. A disk storage device 80 can be connected to local interface 60 to transfer data to and from a nonvolatile disk, for example a magnetic disk, optical disk, or another device. Master system 20 is preferably connected to a network interface 75 that facilitates exchanges of data with network 25.

In an embodiment of the invention, X protocol is generally utilized to render 2D graphical data, and OpenGL protocol (OGL) is generally utilized to render 3D graphical data, although other types of protocols may be utilized in other embodiments. By way of background, OpenGL protocol is a standard application programmer's interface to hardware that accelerates 3D-graphics operations. Although OpenGL protocol is designed to be window system-independent, it is often used with window systems, such as the X Window System, for example. In order that OpenGL protocol may be used in an X Window System environment, an extension of the X Window System is used and is referred to herein as GLX.

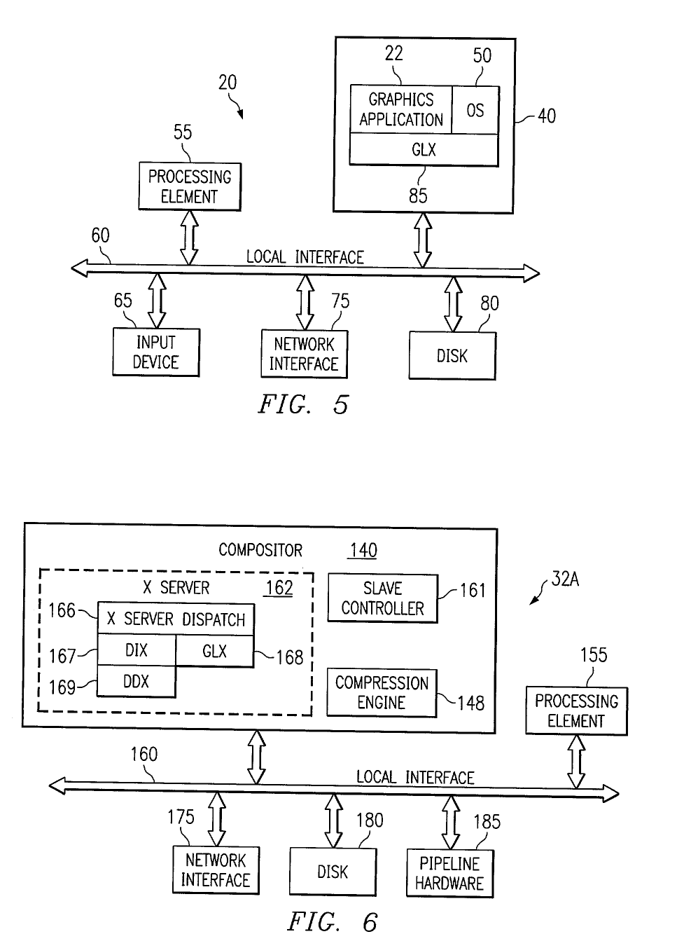

When application 22 issues a graphical command, a client-side GLX layer 85 of master system 20 transmits the command over network 25 to master pipeline 32A. With reference now to FIG. 6, there is illustrated a block diagram of master pipeline 32A that may be implemented in a visualization system according to an embodiment of the present invention. Similar to master system 20, master pipeline 32A includes one or more processing elements 155 that communicate to and drive the other elements therein via a local interface 160, which may comprise one or more buses. A disk storage device 180, such as a nonvolatile magnetic, optic or other data storage device, can be connected to local interface 160 to transfer data therebetween. Master pipeline 32A may be connected to a network interface 175 that allows an exchange of data with LAN 25.

Master pipeline 32A may also include an X server 162. X server 162 may be implemented in software, hardware, or a combination thereof, and in the embodiment shown in FIG. 6, X server 162 is implemented in software and stored in memory 140. Preferably, X server 162 renders 2D X window commands, such as commands to create or move an X window. In this regard, an X server dispatch layer 166 is designed to route received commands to a device independent layer (DIX) 167 or to a GLX layer 168. An X window command that does not include 3D data is interfaced with DIX 167. An X window command that does include 3D data is routed to GLX layer 168(e.g., an X command having embedded OGL protocol such as a command to create or change the state of a 3D image within an X window.) A command interfaced with DIX 167 is executed thereby and potentially by a device dependent layer (DDX) 179, which drives graphical data associated with the executed command through pipeline hardware 185 to frame buffer 33A.

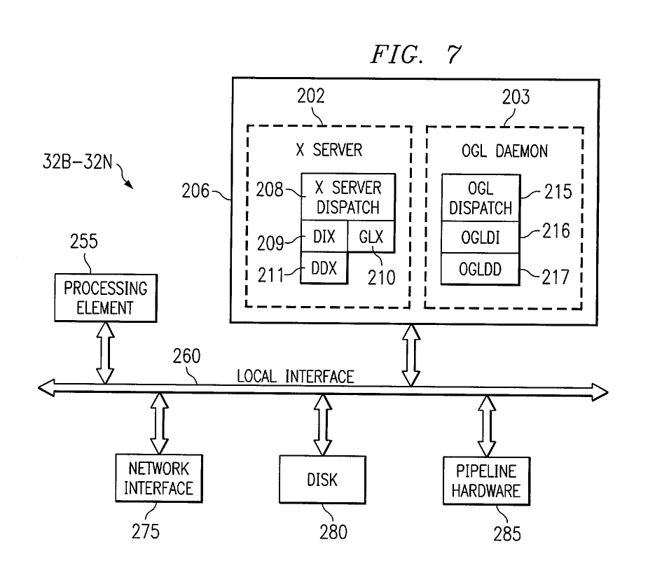

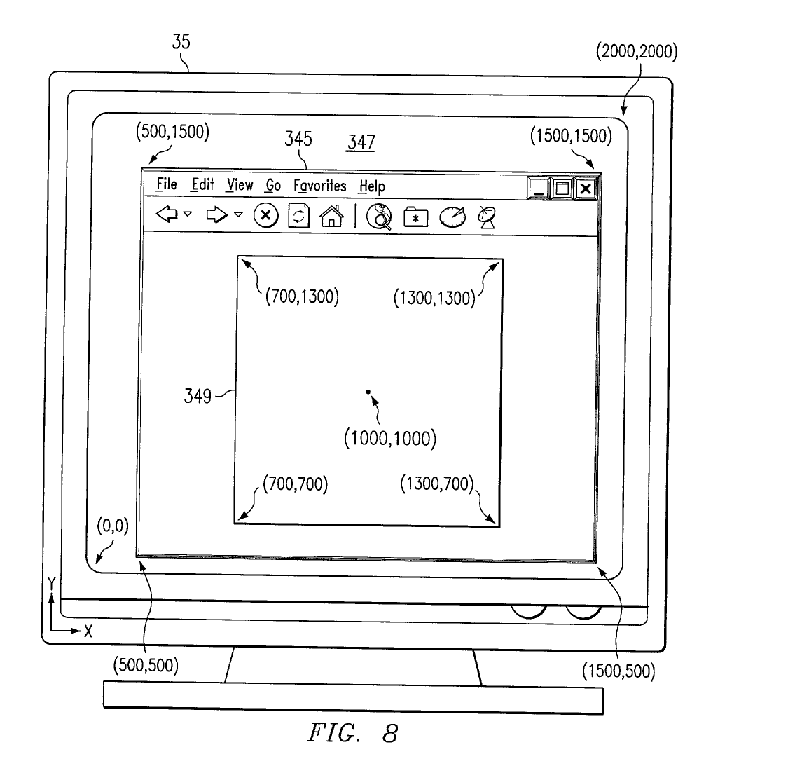

Preferably, each of slave pipelines 33B-33N is configured according to the block diagram of FIG. 7, although other configurations of pipelines 32B-32N are possible. Each of slave pipelines 32B-32N includes an X server 202, similar to X server 162 discussed hereinabove, and an OGL daemon 203. X server 202 and OGL daemon 203 may be implemented in software, hardware, or a combination thereof, and in the embodiment shown in FIG. 7, X server 202 and OGL daemon 203 are implemented in software and stored in memory 206. Similar to graphics application 22 and master pipeline 32A, each of slave pipelines 32B-32N include one or more processing elements 255 that communicate to and drive other elements within pipeline 32B-32N via a local interface 260, which may comprise one or more buses. A disk storage mechanism 280 can be connected to local interface 260 to transfer data to and from a nonvolatile disk. Each pipeline 32B-32N is preferably connected to a network interface 275 that enables pipeline 32B-32N to exchange data with network 25.

X server 202 comprises an X server dispatch layer 208, a GLX layer 210, a DIX layer 209, and a DDX layer 211. Preferably, each command received by slave pipelines 32B-32N includes 3D-graphical data while X server 162 of master pipeline 32A executes each X window command that does not include 3D-graphical data. X server dispatch layer 208 interfaces the 2D data of any received commands with DIX layer 209 and interfaces the 3D data of any received commands with GLX layer 210. DIX layer 209 and DDX layer 211 are configured to process or accelerate the 2D data and to drive the 2D data through pipeline hardware 285 to one of frame buffers 33B-33N.

GLX layer 210 interfaces the 3D data with OGL dispatch layer 215 of OGL daemon 203. OGL dispatch layer 215 interfaces this data with an OGL DI layer 216. OGL DI layer 216 and OGL DD layer 217 are configured to process the 3D data and to accelerate or drive the 3D data through pipeline hardware 285 to an associated frame buffer 33B-33N. Thus, the 2D-graphical data of a received command is processed or accelerated by X server 202, and the 3D-graphical data of the received command is processed or accelerated by OGL daemon 203.

Preferably, slave pipelines 32B-32N, based on inputs from master pipeline 32A, are configured to render 3D images based on the graphical data from master pipeline 32A, according to one of three modes of operation: the optimization mode, a super-sampling mode, and a jitter mode. In the optimization mode, each of slave pipelines 32B-32N renders a different portion of a 3D image such that the overall process of rendering the 3D image is faster. In the super-sampling mode, each portion of a 3D image rendered by one or more of slave pipelines 32B-32N is super-sampled in order to increase quality of the 3D image via anti-aliasing. In the jitter mode, each of slave pipelines 32B-32N renders the same 3D image but slightly offsets each rendered 3D image with a different offset value. Compositor 140 then averages the pixel data of each pixel for the 3D images rendered by pipelines 32B-32N in order to produce a single 3D image of increased image quality.

With reference again to FIG. 2, the operation and interaction of application 22, pipelines 32A-32N and compositor 140 will now be described in more detail according to an embodiment of the invention while system 10 operates in the optimization mode. Master pipeline 32A, in addition to controlling the operation of slave pipelines 32B-32N as described hereinafter, is used to create and manipulate an X window to be displayed by display device 35. Furthermore, each of slave pipelines 32B-32N is used to render 3D graphical data within a portion of the X window.

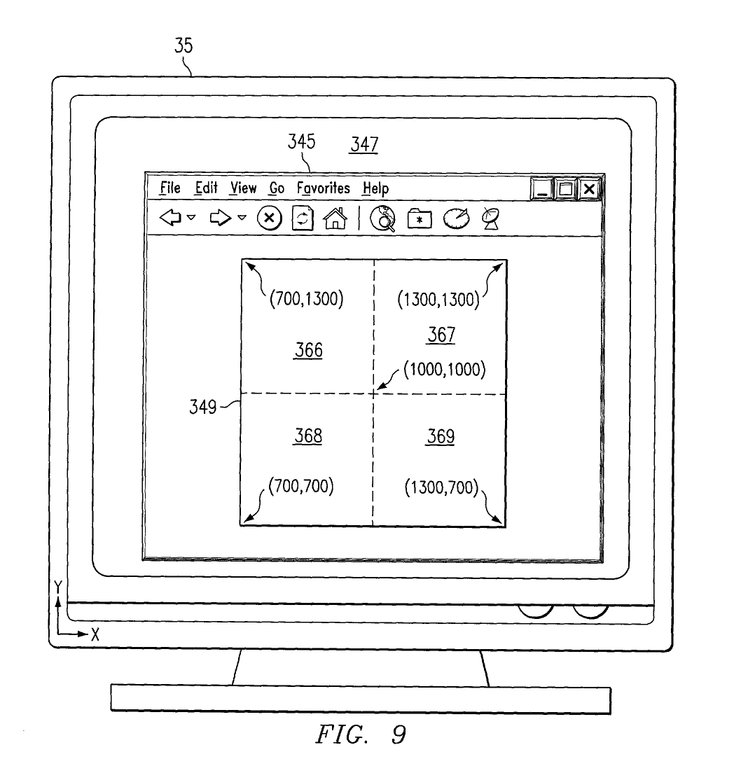

For the purpose of illustrating the aforementioned embodiment, assume that the application 22 issues a function call, i.e. master system 20 executes a function call within application 22 via processing element 55, for creating an X window having a 3D image displayed within the X window. FIG. 8 depicts a frontal view of display device 35 displaying window 345 on a screen 347 thereof according to an exemplary prior art compositing technique. While the particular compositing techniques described with reference to FIG. 8, and those described hereinbelow with reference to FIGS. 10 and 13, may be implemented in an embodiment of the invention, it should be understood that the illustrated compositing techniques are exemplary only and numerous others may be substituted therefor. In the illustrative example shown by FIG. 8, screen 347 is 2000 pixels by 2000 pixels and X windows 345 is 1000 pixels by 1000 pixels. Window 345 is offset from each edge of screen 347 by 500 pixels. Assume 3D-graphical data is to be rendered in a center region 349 of X window 345. Center region 349 is offset from each edge of window 345 by 200 pixels.

In response to execution of the function call by master system 20, application 22 transmits to master pipeline 32A a command to render X window 345 and a command to render a 3D image within portion 349 of X window 345. The command for rendering X window 345 should comprise 2D-graphical data defining X window 345, and the command for rendering the 3D image within X window 345 should comprise 3D-graphical data defining the 3D image to be displayed within region 349. Preferably, master pipeline 32A renders 2D-graphical data from the former command via X server 162.

The graphical data rendered by any of pipelines 32A-32N comprises sets of values that respectively define a plurality of pixels. Each set of values comprises at least a color value and a plurality of coordinate values associated with a pixel. The coordinate values define the pixel's position relative to the other pixels defined by the graphical data, and the color value indicates how the pixel should be colored. While the coordinate values indicate the pixel's position relative to the other pixels defined by the graphical data, the coordinate values produced by application 22 are not the same coordinate values assigned by display device 35 to each pixel of screen 347. Thus, pipelines 32A-32N should translate the coordinate values of each pixel rendered by pipelines 32A-32N to the coordinate values used by display device 35 to display images. The coordinate values produced by application 22 are often said to be “window-relative,” and the aforementioned coordinate values translated from the window-relative coordinates are said to be “screen-relative.” The concept of translating window-relative coordinates to screen-relative coordinates is well known, and techniques for translating window-relative coordinates to screen-relative coordinates are employed by most conventional graphical display systems.

In addition to translating coordinates of 2D data rendered by master pipeline 32A from window-relative to screen-relative, master pipeline 32A in each mode of operation also assigns a particular color value, referred to hereafter as the ‘chroma-key’ to each pixel within region 349. The “chroma-key” indicates which pixels within X window 345 may be assigned a color value of a 3D image that is generated by slave pipelines 32B-32N In this regard, each pixel assigned the chroma-key as the color value by master pipeline 32A is within region 349 and, therefore, may be assigned a color of a 3D object rendered by slave pipelines 32B-32N. In the example shown by FIG. 8, the graphical data rendered by master pipeline 32B and associated with screen-relative coordinate values ranging from (700, 700) to (1300, 1300) are assigned the chroma-key as their color value by master pipeline 32A since region 349 is the portion of X window 345 that is to be used for displaying 3D images.

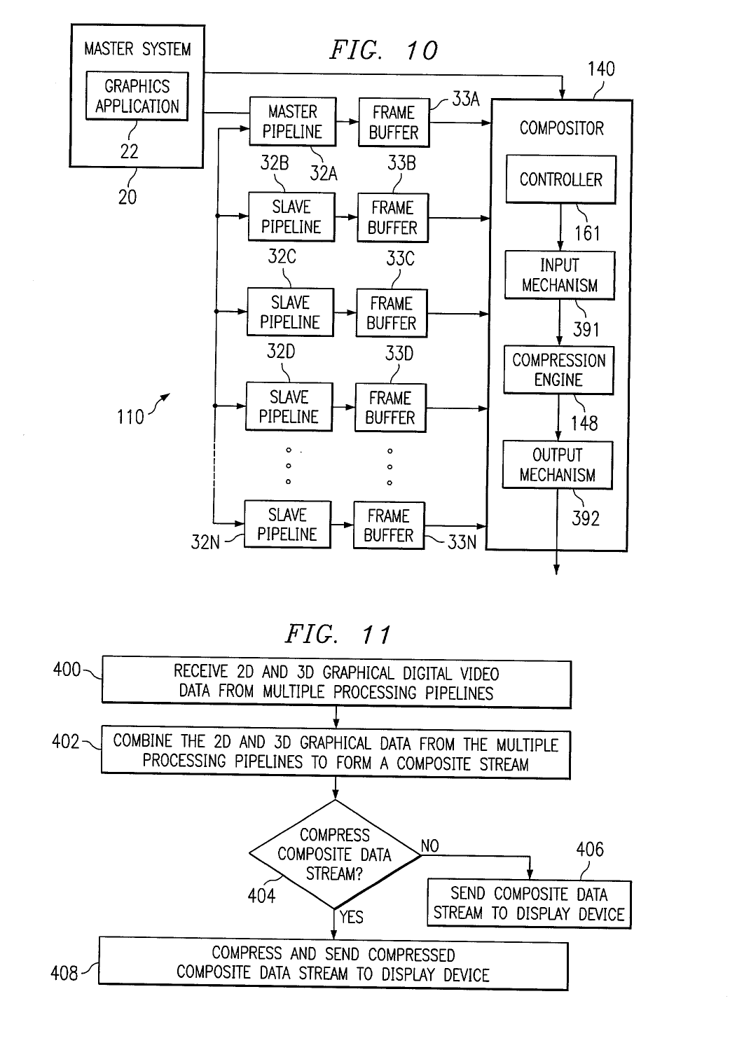

As shown by FIG. 6, master pipeline 32B includes a slave controller 161 that is configured to provide inputs to each slave pipeline 32B-32N over network 25. Slave controller 161 may be implemented in software, hardware, or a combination thereof, and in the embodiment shown in FIG. 6, slave controller 161 is implemented in software and stored in memory 140. The inputs from slave controller 161 inform slave pipelines 32B-32N of which mode each slave pipeline 32B-32N should presently operate. In the present example, slave controller 161 transmits inputs to each slave pipeline 32B-32N that define a particular mode in which each slave pipeline 32B-32N should presently operate. In the present example, slave controller 161 transmits inputs to each slave pipeline 32B-32N directing operation in optimization mode thereby. Inputs from slave controller 161 also indicate which portion of region 349 that is each slave pipeline's 32B-32N rendering responsibility. For example, assume for illustrative purposes, that each slave pipeline 32B-32N is responsible for rendering the graphical data displayed in one of a respective portion 366-369, as shown in the frontal view of display device 35 of FIG. 9.

In this regard, assume that slave pipelines 32B-32N comprise four slave pipelines 32B-32E. In the present example, each slave pipeline 32B-32E is responsible for a respective portion 366-369, that is slave pipeline 32B is responsible for rendering graphical data to be displayed in portion 366 (screen-relative coordinates (700, 1000) to (1000, 1300)), slave pipeline 32C is responsible for rendering graphical data to be displayed in portion 367 (screen-relative coordinates (1000, 1000) to (1300, 1300)), slave pipeline 32D is responsible for rendering graphical data to be displayed in portion 368 (screen-relative coordinates (700, 700) to (1000, 1000)), and slave pipeline 32E is responsible for rendering graphical data to be displayed in portion 369 (screen-relative coordinates (1000, 700) to (1300, 1000)). The inputs transmitted by slave controller 161 to slave pipelines 32B-32E preferably indicate the range of screen coordinate values that each slave pipeline 32B-32E is responsible for rendering. Note that the partition of region 349 can be divided among slave pipelines 32B-32E via other configurations, and it is not necessary for each pipeline 32B-32E to be responsible for an equally-sized area of region 349.

Each slave pipeline 32B-32E is configured to receive from master pipeline 32A the graphical data of the command for rendering the 3D image to be displayed in region 349 and to render this data to frame buffers 33B-33E, respectively. In this regard, each pipeline 32B-32E renders graphical data defining a 2D X window that displays a 3D image within the window. More specifically, slave pipeline 32B renders graphical data to frame buffer 33B that defines an X window displaying a 3D image within portion 366. X server 202 maintained by slave pipeline 32B renders the data that defines the foregoing X window, and OGL daemon 203 maintained by slave pipeline 32B renders the data that defines the 3D image displayed within X window 345. Slave pipeline 32C renders graphical data to frame buffer 33C that defines an X window displaying a 3D image within portion 367. X server 202 maintained by slave pipeline 32C renders the data that defines X window 345, and OGL daemon 203 maintained by slave pipeline 32C renders the data that defines the 3D image displayed within the foregoing X window. Similarly, slave pipelines 32D-32E render graphical data to respective frame buffers 33D-33E via X server 202 and OGL daemon 203 maintained by slave pipelines 32D-32E.

Note that the graphical data rendered by each pipeline 32B-32E defines a portion of the overall image to be displayed within region 349. Thus, it is not necessary for each pipeline 32B-32E to render all of the graphical data defining the entire 3D image to be displayed in region 349. Preferably, each slave pipeline 32B-32E discards the graphical data that defines a portion of the image that is outside of the pipeline's responsibility. In this regard, each pipeline 32B-32E receives from master pipeline 32A the graphical data that defines the 3D image to be displayed in region 349. Each pipeline 32B-32E, based on the aforedescribed inputs received from slave controller 161, then determines which portion of this graphical data is within pipeline's responsibility and discards the graphical data outside of this portion prior to rendering to the associated buffer 33B-33E.

Bounding box techniques may be employed to enable each slave pipeline 32B-32E to quickly discard a large amount of graphical data outside of the respective pipeline's responsibility before significantly processing such graphical data. Accordingly, each set of graphical data transmitted to pipelines 32B-32E may be associated with a particular set of bounding box data. The bounding box data defines a graphical bounding box that contains at least each pixel included in the graphical data this is associated with the bounding box data. The bounding box data can be quickly processed and analyzed to determine whether a pipeline 32B-32E is responsible for rendering any of the pixels included within the bounding box. If a pipeline 32B-32E is responsible for rendering any of the pixels included within the bounding box, then that pipeline renders the received graphical data that is associated with the bounding box. If pipeline 32B-32E is not responsible for rendering any of the pixels included within the bounding box, then that pipeline discards the received graphical data that is associated with the bounding box and does not attempt to render the discarded graphical data. Thus, processing power is not wasted in rendering any graphical data that defines an object outside of a partition 366-369 assigned to a particular pipeline 32B-32E. After pipelines 32B-32E have respectively rendered graphical data to frame buffers 33B-33E, the graphical data is read out of frame buffers 32B-32E through conventional techniques and transmitted to compositor 140 and combined into a single data stream.

It should be noted that master pipeline 32A has been described herein as only rendering 2D graphical data. However, it is possible for master pipeline 32A to be configured to render other types of data, such as 3D image data, as well. In this regard, master pipeline 32A may also include an OGL daemon similar to OGL daemon 203 maintained by slave pipelines 32B-32N. The purpose for having master pipeline 32A only execute graphical commands that do not include 3D image data is to reduce the processing burden on master pipeline 32A because master pipeline 32A performs various functions not performed by slave pipelines 32B-32N. In this regard, executing graphical commands including only 2D image data is generally less burdensome than executing commands including 3D image data. However, it may be possible and desirable in some implementations to allow master pipeline 32A to share in the execution of graphical commands that include 3D image data. Furthermore, it may also be possible and desirable in some implementations to allow slave pipelines 32B-32N to share in the execution of graphical commands that do not include 3D image data.

In FIG. 10, there is a block diagram of system 110 having a compositor 140 according to an embodiment of the present invention. Computer graphical display system 110 comprises a master system 20, master pipeline 32A, and one or more slave pipelines 32B-32N. Master pipeline 32A receives graphical data from an application 22 stored in master system 20. Master pipeline 32A preferably renders 2D-graphical data to frame buffer 33A and routes 3D-graphical data to slave pipelines 32B-32N, which render the 3D-graphical data to frame buffers 33B-33N, respectively. Frame buffers 33A-33N each output a stream of graphical data to compositor 140, which is configured to composite or combine each of the data streams into a single, composite data stream. The composite data stream may then be provided to compression engine 148 and a compressed data stream may be forwarded to an output mechanism, such as a network interface to public network 147, that transmits the compressed data stream to a remote client 30 for display thereby on display device 35.

Compositor 140 may be implemented in hardware, software, firmware, or a combination thereof. Compositor 140, in general, comprises an input mechanism 391, an output mechanism 392, a controller 161 and compression engine 148. As described in detail hereinafter, controller 161 enables input mechanisms 391 to appropriately combine or composite the data streams from the various pipelines so as to provide a composite data stream which is suitable for rendering. In order to facilitate control of input mechanism 391, compositor 140 may receive control information from master system 20, with such control information being provided to controller 392 via a transmission media 394, such as a universal serial bus, for example, or one of pipelines 32A-32N.

As embodiments of compositor 140, components thereof, and associated functionality may be implemented in hardware, software, firmware, or a combination thereof, those embodiments implemented at least partially in software can be adapted to run on different platforms and operating systems. In particular, logical functions implemented by compositor 140 may be provided as an ordered listing of executable instruction that can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions.

In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electro-magnetic, infrared, or semi-conductor system, apparatus, device, or propagation medium now known or later developed, including (a non-exhaustive list): an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

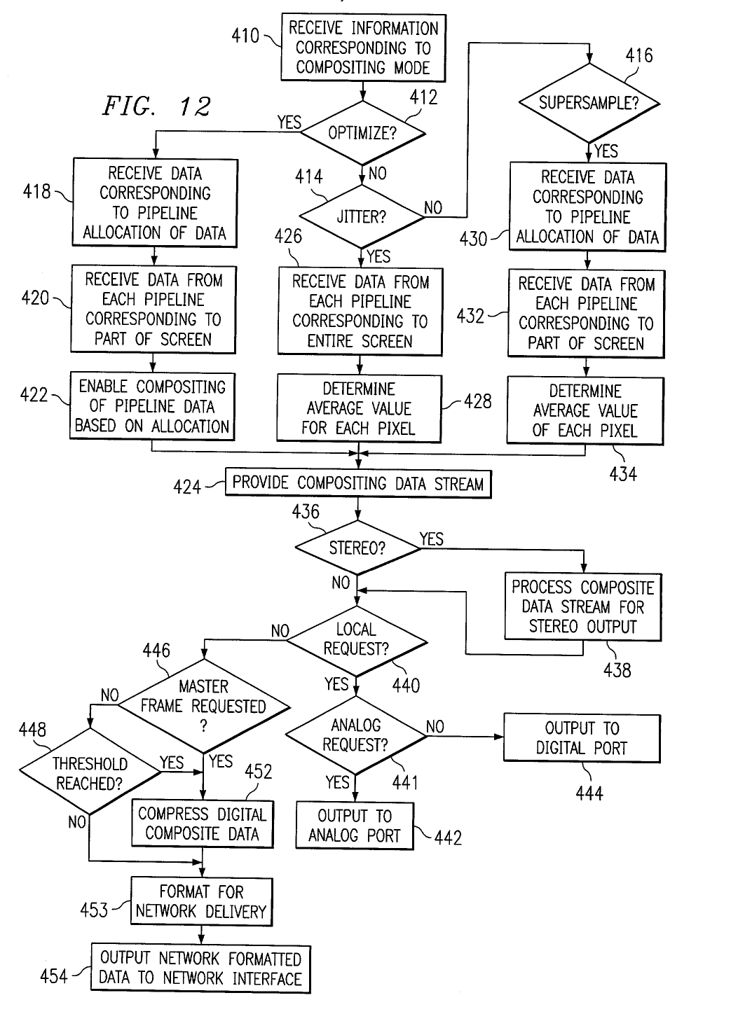

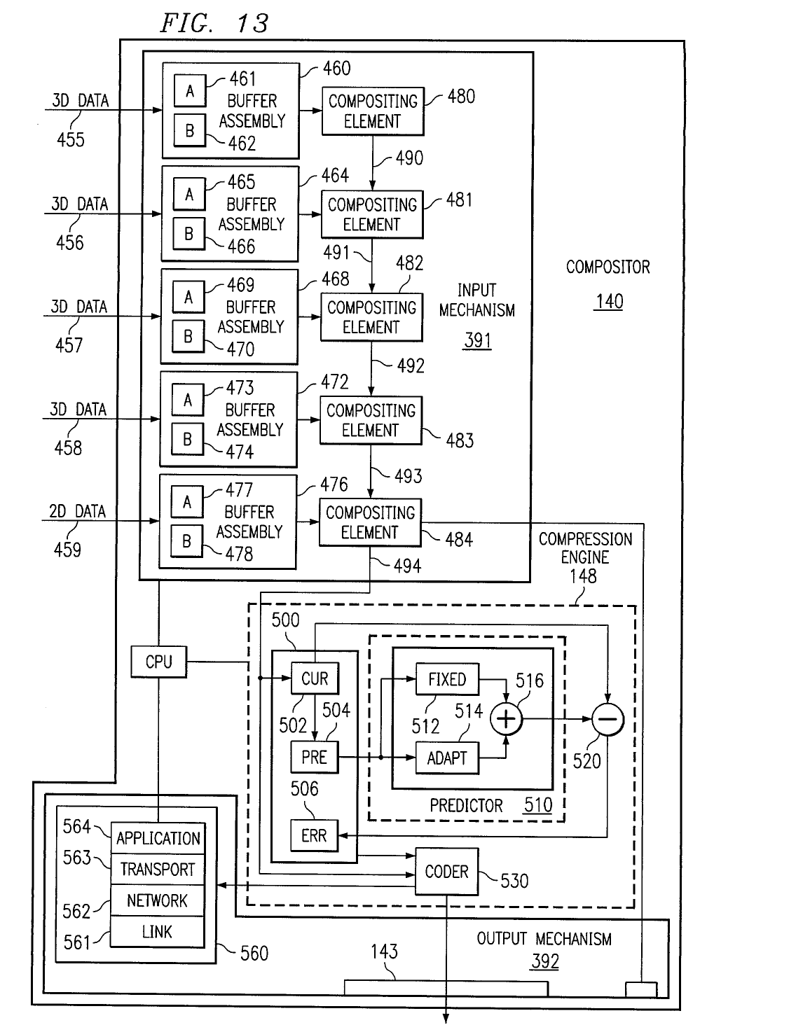

Reference will now be made to the flowcharts of FIGS. 11 and 12, which depict functionality of preferred embodiments of compositor 140. In this regard, each block of the flowcharts represents one or more executable instructions for implementing the specified logical function or functions. It should be noted that in some alternative implementations, the functions noted in the various blocks of FIG. 12 may occur out of the order depicted in the respective figures depending upon the functionality involved. Referring now to

FIG. 11, shows a flowchart depicting a simplified functionality of the compositor according to an embodiment of the present invention. Beginning at block 400, where 2D- and 3D-graphical data relating to an image to be rendered, such as graphical data provided from multiple processing pipelines are received. In block 402, the graphical data are combined to form a composite data stream containing data corresponding to the image. Thereafter, an evaluation may be made to determine whether the composite data is to be compressed (block 404). If compression of the composite data is not performed, the composite data may be output to a display device (block 406). Confirmation of a decision to compress the composite data results in transmission of a compressed composite data stream being transmitted to a display device thereafter (block 408).

In regard to the functionality or process depicted in FIG. 12, the compositing process may be construed as beginning at block 410 where information corresponding to a particular compositing mode or format is received. Thereafter, such as depicted in blocks 412, 414 and 416, determinations are made as to whether the compositing mode information corresponds to one of an optimization mode (block 412), a jitter mode (block 414), or a super-sample mode (block 416).

If it is determined that the information corresponds to the optimization mode, the process may proceed to block 418 where information corresponding to the allocation of pipeline data is received. In this mode, each graphical processing pipeline is responsible for processing information relating only to a portion of the entire screen resolution being processed. Therefore, the information corresponding to the allocation of pipeline data relates to which portion of the screen corresponds to which pipeline. Proceeding to block 420, data is received from each pipeline with the data from each pipeline corresponding to a particular screen portion. It should be noted that the pipeline that processes the 2D-graphical information may process such 2D-graphical data for the entire screen resolution. Thus, the description of blocks 418 and 420 relate most accurately to the processing of 3D-graphical data. Thereafter, such as in block 422, compositing of pipeline data with regard to the aforementioned allocation of data is enabled. In block 424, a composite data stream, e.g., a data stream containing pixel data corresponding to the entire screen resolution (2000 pixels by 2000 pixels, for example) is provided.

If it is determined in block 414 that the information received in block 410 corresponds to the jitter or accumulate mode, the process proceeds to block 426 where pixel data from each pipeline corresponding to the entire screen resolution, e.g., 2000 pixels by 2000 pixels, is received. Thereafter, such as in block 428, an average value for each pixel may be determined utilizing the pixel data from each of the pipelines. After block 428, the process may proceed to block 424, as described hereinabove.

If it is determined in block 416 that the information received in block 410 corresponds to the super-sample mode, the process proceeds to block 430. As depicted therein, information corresponding to the allocation of pipeline data is received. For instance, the 3D-graphical data may be equally divided among the pipelines designated for processing 3D data. Continuing with this representative example, each of the pipelines also may be allocated a screen portion corresponding to 1000 pixels by 1000 pixels. Thereafter, such as depicted in block 432, data is received from each pipeline that corresponds to the aforementioned screen portion allocation. However, the data of each pipeline has been super-sampled during processing so that the received data from each pipeline corresponds to a screen size that is larger than its screen portion allocation. For example, data from each pipeline may correspond to a screen resolution of 2000 pixels by 2000 pixels, e.g., each of the horizontal and vertical dimensions may be doubled. Thus, each pipeline provides four pixels of data for each pixel to be rendered. In other configurations, each of the pipelines may provide various other numbers of pixels of data for each pixel to be rendered.

Proceeding to block 434, the super-sampled data is then utilized to determine an average value for each pixel to be rendered by each pipeline. More specifically, since each pixel to be rendered was previously super-sampled into four pixels, determining an average value for each pixel preferably includes down-sampling each grouping of four pixels back into one pixel. Thus, in the aforementioned example, data from each pipeline is down-sampled and the data from each pipeline, which is representative of a portion of the entire screen resolution, is then composited in block 424, as describe hereinabove.

After the composite data stream has been provided, such as depicted in block 424, a determination may then be made as to whether stereo output is desired (block 436). If it is determined that stereo processing is desired, the process may proceed to block 438 where stereo processing is facilitated. If it was determined in block 436 that stereo processing was not desired or, alternatively, after facilitating stereo processing in block 438, the process proceeds to block 440. As depicted in block 440, a determination may be made as to whether the requested image is destined for a local display or a remote display. If the image request is determined to be local, an evaluation is then made whether a destination display device is analog or digital at block 441 and thereafter the image is appropriately formatted. Accordingly, the process may proceed to block 442 where the composite data stream may be converted to an analog data stream and output to an analog port or, alternatively, if a digital video output is desired, the process may proceed to block 444 where output of digitized composite data to a digital port is made. If the image request is determined to be non-local, that is the image request is for delivery to a remote client, processing may proceed to block 446.

Upon a determination that composite data is to be transmitted to a remote client, the digital composite data may then be compressed prior to transmission across the network. Preferably, the system of the present invention performs one or more decision steps that may result in bypassing of a compression operation on composite image data. Bypassing compression of full composite images may be made by encoding error images, motion vectors, or other image data that may be used by a client for generating images.

The particular compression scheme implemented by the compositing system of the present invention may be any one or more of various well-known compression techniques, such as JPEG-LS, and/or the compression may be performed according to proprietary methods. In a preferred embodiment, the compression technique performed by the compositing system is an inter-frame compression routine. Inter-frame compression is well-known and, thus, a detailed description thereof is unnecessary. Briefly, inter-frame compression is a technique that uses information from a previous image(s) to facilitate generation of a subsequent image. Other information may be derived that may be used in conjunction with a previous image to form an image subsequent to the previous image. For example, a difference image may be derived that represents changes in a previous image that, when combined therewith, represent a subsequent image. Motion-estimated predictor images may be produced that are generated from a previous image and objects having motion vectors assigned thereto that define the objects translation from one image to another. These (and numerous others) techniques may be implemented to reduce the amount of data required to represent a sequence of images. In general, inter-frame compression relies on a series of ‘key’ or ‘master’ image frames that comprise full image data, such as composited digital data, with one or more image frames intermediate each set of adjacent key frames. The one or more intermediate frames (or the requisite data for generating the intermediate frames) may be derived from a previous key frame, a previous intermediate frame, difference image data, motion vectors, and/or other data. While some inter-frame compression techniques may rely on previously rendered frames and/or subsequently rendered frames for generating a difference image, or other data, used to form an intermediate image, it is preferable that a system implementing the teachings of the invention employ an inter-frame compression routine that relies only on previously rendered image frames to alleviate latency issues.

Returning again to FIG. 12, upon confirmation that the digital composite data is destined for a non-local client, an evaluation may be made of whether the data to be transmitted to a remote client is a master frame at block 446. Confirmation that the digital data is a master frame may result in compression of the data at block 452. Compression may be performed on non-master frame data by performing a threshold evaluation of non-master frame data (block 448). For example, inter-frame compression techniques often employ coding of a master frame at predefined intervals. Thus, a maximum number of frames intermediate two master frames may be defined as a threshold or, similarly, a threshold may define a period of time for which coding of a master frame is required. Another threshold may specify a maximum deviation from a previous master frame that, when exceeded, causes coding of a master frame to be performed. For example, a compression algorithm implementing a predictor may produce an error image that may be transmitted to a client. A specified deviation from a previous frame may be defined that, when exceeded, results in coding and transmission of a new master frame to the client node. Other thresholds may be defined as well. If non-master frame composite digital data fails to meet a specified threshold, intermediate image data (such as an error image, motion vector, and/or other information) may be formatted (block 453) for network delivery (for example, packetized, encapsulated and addressed to the remote client in one or more IP or other routable network protocol formats) to the remote client. However, if non-master frame composite digital data does meet the pre-defined threshold, a complete composite master image may be compressed (block 452) and thereafter formatted (block 453) for delivery over network 147. Network formatted data may then be output via a network interface (block 454).

Referring now to FIG. 13, a block diagram of a preferred embodiment of input mechanism 391, output mechanism 392, and compression engine 148 is shown. Input mechanism 391 is configured to receive multiple data streams, e.g., data streams 455-459 is shown. In particular, the data streams are provided by pipelines, such as pipelines 32A-32N of FIG. 10, with the data being intermediately provided to corresponding frame buffers, such as buffers 33A-33N. Each of the data streams 455-459 is provided to a buffer assembly of the input mechanism 391 that preferably includes two or more buffers, such as frame buffers or line buffers, for example. More specifically, in the embodiment depicted in FIG. 13, data stream 455 is provided to buffer assembly 460, which includes buffers 461 and 462, data stream 456 is provided to buffer assembly 464, which includes buffers 465 and 466, data stream 457 is provided to buffer assembly 468, which includes buffers 469 and 470, data stream 458 is provided to buffer assembly 472, which includes buffers 473 and 474, and data stream 459 is provided to buffer assembly 476, which includes buffers 477 and 478. Although data stream 459 is depicted as comprising 2D data, for example data that may be provided by master pipeline 32A, the 2D data may be provided to any of the frame buffer assemblies.

The buffers of each buffer assembly cooperate so that a continuous output stream of data may be provided from each of the buffer assemblies. More specifically, while data from a particular data stream is being written to one of the pair of buffers of a buffer assembly, data is being read from the other of the pair. In other embodiments, buffer assemblies may be provided with more than two buffers that are adapted to provide a suitable output stream of data. Additionally, in still other embodiments, the pipelines may provide pixel data directly to respective compositing elements without intervening buffers being provided therebetween. While it is preferred that the buffer assemblies comprise two or more buffers, a buffer assembly comprising a single buffer may be substituted therefor.

In the embodiment depicted in FIG. 13, each of the frame buffer assemblies communicates with a compositing element. For example, buffer assembly 460 communicates with compositing element 480, buffer assembly 464 communicates with compositing element 481, buffer assembly 468 communicates with compositing element 482, buffer assembly 472 communicates with compositing element 483, and buffer assembly 476 communicates with compositing element 484. So configured, each buffer assembly is able to provide its respective compositing element with an output data stream.

Each compositing element communicates with an additional compositing element for forming the composite data stream. More specifically, compositing element 480 communicates with compositing element 481, compositing element 481 communicates with compositing element 482, compositing element 482 communicates with compositing element 483, and compositing element 483 communicates with compositing element 484. So configured, data contained in data stream 455 is presented to compositing element 480 via buffer assembly 460. In response thereto, compositing element 480 outputs data in the form of data stream 490, which is provided as an input to compositing element 481. Compositing element 481 also receives an input corresponding to data contained in data stream 456 via buffer assembly 464. Compositing element 481 then combines or composites the data provided from buffer assembly 464 and compositing element 480 and outputs a data stream 491. Thus, data stream 491 includes data corresponding to data streams 455 and 456. Compositing element 482 receives data stream 491 as well as data contained within data stream 457, which is provided to compositing element 482 via buffer assembly 468. Compositing element 482 composites the data from data stream 491 and data stream 457, and then outputs the combined data via data stream 492. Compositing element 483 receives data contained in data stream 492 as well as data contained within data stream 458, which is provided to compositing element 483 via frame buffer 472. Compositing element 483 composites the data from data stream 492 and data stream 458, and provides an output in the form of data stream 493. Data stream 493 is provided as an input to compositing element 484. Additionally, compositing element 484 receives data corresponding to data stream 459, which is provided via buffer assembly 476. Compositing element 484 then composites the data from data stream 493 and data stream 459, and provides a combined data stream output as composite data stream 494. Composite data stream 494 then is provided to compression engine 148 and output to network 147 (not shown) via network interface 143.

Compositing of the multiple data streams preferably is facilitated by designating portions of a data stream to correspond with particular pixel data provided by the aforementioned pipelines. In this regard, compositing element 480, which is the first compositing element to provide a compositing data stream, is configured to generate a complete frame of pixel data, i.e., pixel data corresponding to the entire resolution to be rendered. This complete frame of pixel data is provided by compositing element 480 as a compositing data stream. In response to receiving the compositing data stream, each subsequent compositing element may then add pixel data, i.e., pixel data corresponding to its respective pipeline, to the compositing data stream. After each compositing element has added pixel data to the compositing data stream, the data stream then contains pixel data corresponding to data from all of the aforementioned pipelines. Such a data stream, i.e., a data stream containing pixel data corresponding to data from all of the processing pipelines, may be referred to herein as a combined or composite data stream.

The first compositing element to provide pixel data to a compositing data stream, e.g., compositing element 480, also may provide video timing generator (VTG) functionality. Such VTG functionality may include, for example, establishing horizontal-scan frequency, establishing vertical-scan frequency, and establishing dot clock, among others.

Composite data stream 494 comprises pixel data representative of sequences of images that may be displayed on a display device and may be input into compression engine 148. As mentioned hereinabove, compression engine 148 may be implemented by any one or more of numerous compression techniques. The exemplary compression engine 148 employs one or more inter-frame compression techniques. Accordingly, compression engine 148 may comprise an image buffer 500, a predictor 510, and a coder 530. A composite image input to image buffer 500 may be stored in a current image buffer 502. Image buffer 500 may have a previous image buffer 504 that stores a previous composite image input to image buffer 500 via composite data stream 494. Thus, as composite image sequences are input to image buffer 500, the most recent composite image is maintained in current image buffer 502 and the composite image previously stored in current image buffer 502 is shifted into previous image buffer 504.

The composite image stored in current image buffer 502 may be estimated by predictor 510. The composite image stored in previous image buffer is input into predictor 510. Predictor 510 may comprise one or more functional units, such as modeling algorithms or circuitries. Preferably, predictor 510 implements autoregressive modeling techniques and comprises a fixed predictor 512 and an adaptive predicator 514. Fixed predictor 512, in general, generates image prediction data based on prior knowledge of image structure data, for example image data of a composite image stored in previous image buffer 504. A predictor step, in essence, estimates a subsequent sample, for example a current image, based on a future subset of available past data, for example a previous image. Image buffer 500 may have multiple previous image buffers for storing a sequence of previous images and fixed predictor 512 may accordingly be modified to generate predictions based on a plurality of previous images, as is understood in the art. Adaptive predictor 514 estimates a future sample based on model(s) that ‘learn’, or train, from sequences of estimates.

A final predicted image may then be generated by inputting the predicted image estimated by fixed predictor 512 and the predicted image estimated by adaptive predictor 514 into a summer 516, or another functional element that produces a final predicted image based upon output from fixed predictor 512 and adaptive predictor 514. The final predicted image, along with the current image, produced by predictor 510 may then be input into a subtractor 520. A residual image, or error image, may then be determined as a difference between the current image and the final predicted image produced by predictor 510. Other techniques, such as motion estimation techniques, may be utilized by predictor 510 in conjunction with or in lieu of differential estimation techniques. The error image may be stored in an error image buffer 506 of image buffer 500.

The residual image stored in error image buffer 506 may then be processed by coder 530 that performs any one of various compression schemes. Alternatively, a current composite image may be forwarded from input mechanism 391 directly to coder 530 for compression thereof. Compression of a current composite image may be performed for various reasons, such as request of a master frame by the remote client, reaching of a threshold such as a timing threshold, or another criteria.

Compositor 140 may additionally comprise a network stack 560 for facilitating transmission of compressed composite image data, such as compressed error images, compressed master images, and/or other data required by a rendering client for displaying a composite image, across a network. Accordingly, compressed data generated by coder 530 may be provided to network stack 560. Network stack 560 may encapsulate compressed data prior to transmission across network 147. Network stack 560 may be implemented according to various configuration and capabilities and, in general, will include appropriate layers for accommodating compositor hardware and/or interfaces and network 147 protocols. For example, network interface 143 may be an Ethernet interface and network stack 560 may accordingly have an appropriate Ethernet link layer 561 driver. Network 147 may be the Internet and network stack 560 accordingly may have an IP network layer 562 and a transport control protocol driver included as the transport layer 563. A compositor process responsible for managing communications with various nodes may be managed by an application layer 564 of network stack 560.

Generation of a composite data stream will now be described with reference to the schematic diagrams of FIGS. 10 and 13. As mentioned briefly hereinabove in regard to FIG. 9, a particular slave pipeline is responsible for rendering graphical data displayed in each of screen portions 366-369. Additionally, 2D-graphical information corresponding to the entire screen resolution, e.g., screen 347, is processed by a separate pipeline. For the purpose of the following discussion, graphical data associated with screen portion 366 corresponds to data stream 455 of FIG. 13, with screen portions 367, 368 and 369 respectively corresponding to data streams 456, 457 and 458. Additionally, 2D-graphical data, which is represented by window 345 of FIG. 9, corresponds to data stream 459 of FIG. 13.

As described hereinabove, data streams 455-459 are provided to their respective buffer assemblies where data is written to one of the buffers of each of the respective buffer assemblies as data is read from the other buffer of each of the assemblies. The data then is provided to respective compositing elements for processing. More specifically, receipt of data by compositing element 480 initiates generation of an entire frame of data by that compositing element. Thus, in regard to the representative example depicted in FIG. 9, compositing element 480 generates a data frame of 2000 pixels by 2000 pixels, e.g., data corresponding to the entire screen resolution 347 of FIG. 9. Compositing element 480 also is programmed to recognize that data provided to it corresponds to pixel data associated with a particular screen portion, e.g., screen portion 366. Therefore, when constructing the frame of data corresponding to the entire screen resolution, compositing element 480 utilizes the data provided to it, such as via its buffer assembly, and appropriately inserts that data into the frame of data. Thus, compositing element 480 inserts pixel data corresponding to screen portion 366, i.e., pixels (700, 1300) to (1000, 1000), into the frame. Those pixels not corresponding to screen portion 366 may be represented by various other pixel information, as desired. For instance, in some embodiments, the data corresponding to remaining portions of the frame may be left as zeros, for example. Thereafter, the generated frame of data, which now includes pixel data corresponding to screen portion 366, may be provided from compositing element 480 as compositing data stream 490. Compositing data stream 490 then is provided to a next compositing element for further processing.

As depicted in FIG. 13, compositing data stream 490 is received by compositing element 481. Compositing element 481 also is configured to receive data from data stream 456, such as via buffer assembly 464, that may contain data corresponding to screen portion 367 of FIG. 9, for example. Thus, compositing element 481 may receive data corresponding to pixels (1000, 1300) to (1300, 1000). Compositing element 481 is configured to insert the pixel data corresponding to pixels of screen portion 367 into the compositing data stream by replacing any data of the stream previously associated with, in this case, pixels (1000, 1300) to (1300, 1000), with data contained in data stream 456. Thereafter, compositing element 481 is able to provide a compositing data stream 491, which contains pixel data corresponding to the entire screen resolution as well as processed pixel data corresponding to pixels (700, 1300) to (1300, 1000), i.e., screen portions 366 and 367.

Compositing data stream 491 is provided to the next compositing element, e.g., compositing element 482. Additionally, compositing element 482 receives pixel data from data stream 457, such as via buffer assembly 468, that corresponds to screen portion 368. Compositing element 482 inserts pixel data from data stream 457 into the compositing data stream and provides a compositing data stream 492 containing data corresponding to the entire frame resolution as well as processed pixel data corresponding to screen portions 366, 367 and 368. Compositing data stream 492 then is provided to compositing element 483. Compositing element 483 receives pixel data from data stream 458, such as via buffer assembly 472, that corresponds to screen portion 369. Compositing element 483 inserts pixel data from data stream 458 into the compositing data stream. Thus, compositing element 483 is able to provide a compositing data stream 493 containing pixel data corresponding to the entire screen resolution as well as processed pixel data corresponding to pixels (700, 1300) to (1300, 700).

Compositing data stream 493 is provided to compositing element 484 which is adapted to receive 2D-processed graphical data, such as via data stream 459 and its associated buffer assembly 476. Data stream 459, in addition to containing the 2D data, also includes a chroma-key value corresponding to pixels that are to be replaced by processed pixel data, e.g., 3D-pixel data contained in compositing data stream 493. For example, the chroma-key value may be assigned a predetermined color value, such as a color value that typically is not often utilized during rendering. So provided, when pixel data corresponding to data stream 459 and pixel data from compositing stream 493 are received by compositing element 484, 2D-pixel data is able to overwrite the pixel data contained within compositing data stream 493, except where the data corresponding to data stream 459 is associated with a chroma-key value. At those instances where a chroma-key value is associated with a particular pixel, the processed data from the compositing data stream remains as the value for that pixel, i.e., the processed data is not overwritten by the chroma-key value. In other words, pixel data from compositing data stream 493 is able to overwrite the pixel data corresponding to data stream 459 only where the pixel data corresponding to data stream 459 already corresponds to the chroma-key value. So configured, compositing element 484 is able to provide a composite data stream 494 which includes pixel data corresponding to each of the processing pipelines.

As mentioned hereinabove, the compositor may facilitate compositing of the various data streams of the processing pipelines in a variety of formats, such as super-sample, optimization, and jitter. In order to facilitate such compositing, each compositing element is configured to receive a control signal from the controller. In response to the control signal, each compositing element is adapted to combine its respective pixel data input(s) in accordance with the compositing format signaled by the controller. Thus, each compositing element is re-configurable as to mode of operation. Regardless of the particular compositing format utilized, however, such compositing preferably is facilitated by serially, iteratively compositing each of the input data streams so as to produce the composite data stream.

Compositing of data utilizing the optimization mode will now be described in greater detail with reference to the embodiment depicted in FIG. 13. As discussed hereinabove, the compositor receives graphical data from multiple pipelines. More specifically, in the optimization mode, each of the pipelines provides graphical data corresponding to a portion of an image to be rendered. Thus, in regard to the embodiment depicted in FIG. 13, buffer assemblies 460, 464, 468 and 472 receive 3D data corresponding to a portion of the image to be rendered, and buffer assembly 476 receives the 2D data.

After receiving data from the respective pipelines, the buffer assemblies provide the data to their respective compositing elements, which have been instructed, such as via control signals provided by controller 161, to composite the data in accordance with the optimization mode. For instance, upon receipt of data from buffer assembly 460, compositing element 480 initiates generation of an entire frame of data, e.g., data corresponding to the entire screen resolution to be rendered. Compositing element 480 also inserts pixel data corresponding to its allocated screen portion into the frame and then generates compositing data stream 490, which includes data associated with an entire frame as well as processed pixel data corresponding to compositing element 480. The compositing data stream 490 then is provided to compositing element 481.

Compositing element 481, which also receives data from data stream 456, inserts pixel data corresponding to its allocated screen portion into the compositing data stream, such as by replacing any data of the stream previously associated with the pixels allocated to compositing element 481 with data contained in data stream 456. Thereafter, compositing element 481 provides a compositing data stream 491, which contains pixel data corresponding to the entire screen resolution, as well as processed pixel data corresponding to compositing elements 480 and 481, to compositing element 482. Compositing element 482 also receives pixel data from data stream 457. Compositing element 482 inserts pixel data from data stream 457 into the compositing data stream and provides a compositing data stream 492, which contains data corresponding to the entire frame resolution as well as processed pixel data corresponding to compositing elements 480, 481, and 482. Compositing data stream 492 then is provided to compositing element 483, which inserts data into the compositing data stream corresponding to its allocated screen portion.

Compositing element 483 receives pixel data from data stream 458 and compositing data stream 492. Compositing element 483 inserts pixel data from data stream 458 into the compositing data stream and provides a compositing data stream 493, which contains data corresponding to the entire frame resolution as well as processed pixel data corresponding to compositing elements 480, 481, 482 and 483. Compositing data stream 493 then is provided to compositing element 484. Compositing element 484 receives compositing data stream 493, which includes 2D-processed graphical data and chroma-key values corresponding to pixels that are to be replaced by processed 3D-pixel data. Thus, in response to receiving the aforementioned data, compositing element 484 enables pixel data from compositing data stream 493 to overwrite the pixel data corresponding to data stream 459 where the pixel data corresponding to data stream 459 corresponds to the chroma-key value. Thereafter, compositing element 484 provides a composite data stream 494, which includes pixel data corresponding to the image to be rendered, to compression engine 148 whereafter the compressed data stream may be encapsulated in one or more data packets addressed to client 30 output via network interface 143. The process may then be repeated for each subsequent frame of data.

In a preferred embodiment of compositor 140, the various functionality depicted in the schematic diagram of FIG. 13 may be implemented by cards which are adapted to interface with a back-plane of compositor 140. More specifically, compositing elements 480 and 481 may be provided on a first input card, compositing elements 482 and 483 may be provided on a second input card, and compositing element 484 may be provided on a third input card. An output card and a controller card also may be provided. Additionally, it should be noted that each of the cards may be interconnected in a “daisy-chain” configuration, whereby each card directly communicates with adjacent cards along the back-plane, although various other configurations may be utilized. However, the “daisy-chain” configuration more conveniently facilitates the serial, iterative compositing techniques employed by preferred embodiments of the present invention.

The foregoing discussion of the compositor has focused primarily on the compositing of multiple digital video data streams to produce a single, composite data stream. The following is a description of preferred methods for delivery and output of a composite data stream. More specifically, the output mechanism, e.g., output mechanism 392 of FIG. 13, will now be described in greater detail.

As depicted in FIG. 13, output mechanism 392 is configured to receive a compressed composite data stream 494 and provide the compressed output composite data stream to network interface 143 for enabling display of an image on a display device. The output composite data stream may be provided in various formats from output mechanism 392 with a particular one of the formats being selectable based upon a control input provided from the controller. For instance, the composite data stream may be provided as the output composite data stream, i.e., the data of the composite data stream is not buffered within the output mechanism. However, the composite data stream may be buffered, such as when stereo output is desired. Buffering of the data of the composite data stream also provides the potential benefit of compensating for horizontal and/or vertical blanking which occurs during the rasterization process as the pixel illumination mechanism of an analog display device transits across the screen between rendering of frames of data.

What is claimed:

1. A method of compositing image partitions and distributing a composite image to a remote node, comprising:
receiving a plurality of image renderings from a respective plurality of rendering nodes;
assembling the plurality of image renderings into a composite image;
compressing the composite image; and
transmitting the compressed composite image across a routable network having the remote node interconnected therewith.

2. The method according to claim 1, wherein receiving a plurality of image renderings from a respective plurality of rendering nodes further comprises receiving the plurality of renderings from the respective plurality of rendering nodes, each of the plurality of renderings defining a respective image portion of the composite image.

3. The method according to claim 1, wherein receiving the plurality of renderings each defining a respective image portion further comprises receiving the plurality of renderings each respectively defining a unique image portion of the composite image.

4. The method according to claim 1, wherein receiving the plurality of renderings each defining a respective image portion further comprises receiving the plurality of renderings, a subset of the plurality of rendering defining a unique image portion of the composite image.

5. The method according to claim 1, wherein transmitting the compressed composite image across a network having the remote node interconnected therewith further comprises transmitting the compressed composite image across a public network having the remote node interconnected therewith.

6. The method according to claim 5, wherein transmitting the compressed composite image across the public network further comprises transmitting the compressed composite image across a public Internet protocol network.

7. A node for assembling image portions into a composite image, comprising:
a processing element;
a routable network interface;
a compositing element operable to receive a first and second data stream input thereto and to assemble the data streams into a composite data stream defining the composite image; and
a memory module maintaining a compression engine executable by the processing element and operable to compress the composite image, the node operable to output the compressed composite image through the network interface.

8. The node according to claim 7, wherein the network interface communicates with a public network.

9. The node according to claim 7, wherein the first and the second data stream respectively comprise viewable image data and non-viewable image data.

10. The node according to claim 7, wherein the compositing element is maintained in the memory module and is executable by the processing element.

11. The node according to claim 7, further comprising:
a second compositing element; and
a buffer assembly, the first data stream input by the second compositing element and the second data stream input by the buffer assembly.

12. The node according to claim 11, wherein the buffer assembly is operable to receive the second data stream from an external rendering node.

13. The node according to claim 12, wherein the buffer assembly further comprises a first and second buffer, the second data stream input to the compositing element from the first buffer while the second buffer receives data and the second data stream input to the compositing element from the second buffer while the first buffer receives data.

14. A network for generating composite images and distributing the composite images to a remote node, comprising:
a plurality of rendering nodes operable to render a respective image portion; and
a compositing node comprising a compositing element operable to receive the respective image portions in respective data streams and assemble the data streams into a composite image, a compression engine operable to compress the composite image, and a network interface operable to transmit the compressed composite image to a routable network in communication therewith.

15. The network according to claim 14, further comprising a master system comprising a graphics application operable to provide each of the plurality of rendering nodes with respective three-dimensional data that defines the respective image portion.

16. The network according to claim 15, wherein the three-dimensional data comprises viewable data and non-viewable data.

17. The network according to claim 14, wherein the compositing node further comprises a plurality of buffer assemblies each operable to receive one of the data streams and provide the respective data stream to one of the compositing elements.

18. The network according to claim 17, wherein at least one of the compositing elements is operable to receive a data stream output from another of the plurality of compositing elements and operable to receive a data stream from one of the plurality of buffer assemblies.
